(19) United States
(12) Patent Application Publication
(10) Pub. No.: US 2024/0330826 A1
(43) Pub. Date: Oct. 3, 2024

(54) MACHINE LEARNING-BASED TARGETING MODEL BASED ON HISTORICAL AND DEVICE TELEMETRY DATA

(71) Applicant: Cisco Technology, Inc., San Jose, CA (US)

(72) Inventors: Evan K Pease, Walnut Creek, CA (US); Liz Williams, Ann Arbor, MI (US)

(21) Appl. No.: 18/295,191

(22) Filed: Apr. 3, 2023

(51) Int. Cl. G06Q 10/0637; H04L 41/0823; H04L 41/14; H04L 41/16

(52) U.S. Cl. CPC G06Q 10/06375; H04L 41/0823; H04L 41/145; H04L 41/16

(57) ABSTRACT

In one aspect, a method includes receiving first data for a plurality of accounts, the first data including information related to feature subscriptions and adoption for each of the plurality of accounts, each account utilizing one or more devices and features of an enterprise network, receiving second data for the plurality of accounts, the second data including telemetry information on network device and feature usage by one or more devices associated with each of the plurality of accounts, and generating, using a trained machine-learning model, an analysis of the plurality of accounts, wherein the machine-learning model receives the first data and the second data as input and provides a likelihood of feature adoption by each of the plurality of accounts.

### FIELD OF THE TECHNOLOGY

The subject matter of this disclosure generally relates to the field of computer networks, and more particularly to utilizing a trained machine learning model that can predict feature usage and adoption by different users of computer networks based on historical feature utilization and device telemetry data.

### BACKGROUND

Enterprise network operators perform manual analyses to understand network usage by their subscribers. By performing these manual analyses, network administrators can attempt to better understand their user behaviors and what features and functionalities different users need/want and how best to target their users for such features and functionalities. The accuracy and case of use of such manual processes are sub-optimal and far from ideal.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example cloud computing architecture according to some aspects of the present disclosure;

FIG. 1B illustrates an example fog computing architecture according to some aspects of the present disclosure;

FIG. 2 illustrates an example machine learning process for account analysis according to some aspects of the present disclosure;

FIG. 3 illustrates an example pipeline for developing a trained machine learning model for account analysis according to some aspects of the present disclosure;

FIG. 4 illustrates an example process of training, testing and evaluating the machine learning model for account analysis described above according to some aspects of the present disclosure;

FIG. 5 illustrates an example neural network that can be utilized for feature definition and analysis according to some aspects of the present disclosure;

FIG. 6 illustrates an example user interface of a dashboard with account analysis results performed using machine learning model described with reference to FIGS. 2-5 according to some aspects of the present disclosure;

FIG. 7 is an example method of account analysis using a machine learning model developed as described with reference to FIGS. 2-6 according to some aspects of the present disclosure; and

FIG. 8 illustrates an example of a computing system according to some aspects of the present disclosure.

### DETAILED DESCRIPTION

Various examples of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and, such references mean at least one of the examples.

Reference to “one example” or “an example” means that a particular feature, structure, or characteristic described in connection with the example is included in at least one example of the disclosure. The appearances of the phrase “in one example” in various places in the specification are not necessarily all referring to the same example, nor are separate or alternative examples mutually exclusive of other examples. Moreover, various features are described which can be exhibited by some examples and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various examples given in this specification.

Without intent to limit the scope of the disclosure, examples of instruments, apparatus, methods and their related results according to the examples of the present disclosure are given below. Note that titles or subtitles can be used in the examples for convenience of a reader, which in no way should limit the scope of the disclosure. Unless otherwise defined, technical and scientific terms herein have the meaning commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### Overview

Enterprise network providers need to understand the confluence of a variety of factors that directly and indirectly influence their users' decision-making process as far as adoption and utilization of an enterprise network and its available features are concerned. Currently, network providers rely on a network of sales representatives as points of contact with their customers. These sales representatives are tasked with ensuring user engagement and constantly look for insights into user trends and behaviors in an attempt to determine how best to maximize adoption of new features and services by these users. In doing so, sales representatives often rely on consumer reports, the creation of which is time-consuming and laborious. These reports fail to provide a holistic overview of any users' historical feature utilization and spend. Moreover, a significant drawback of these reports is that they fail to take into consideration device telemetry data (data collected on devices and features currently in use by any given user of an enterprise network) in understanding users' behavior and trends in how they use current features to which they are subscribed. Such telemetry data that can provide valuable information as to feature usage and adoption trends, frequency of use, etc.

The present disclosure provides an objective approach to understanding an account. An account may be defined for each user/customer of an enterprise network. As will be described below, this objective approach utilizes a trained machine learning model that may receive, as input, historical spend data for any given account (over a period of time) and device telemetry data that may be collected, using various techniques, of network devices and features currently used by any given user. The output of the machine learning model may be a ranking of accounts with information on likelihood of future spend, likely features and network devices to be adopted by each account, predicted amount of spend over a given period of time, etc.

In one aspect, a method includes receiving first data for a plurality of accounts, the first data including information related to feature subscriptions and adoption for each of the plurality of accounts, each account utilizing one or more devices and features of an enterprise network, receiving second data for the plurality of accounts, the second data including telemetry information on network device and feature usage by one or more devices associated with each of the plurality of accounts, and generating, using a trained machine-learning model, an analysis of the plurality of accounts, wherein the machine-learning model receives the first data and the second data as input and provides a likelihood of feature adoption by each of the plurality of accounts.

In another aspect, the first data further includes historical spend data for each of the plurality of accounts.

In another aspect, the second data is received via one or more sensors deployed throughout the enterprise network.

In another aspect, the analysis is visually presented on a dashboard.

In another aspect, the analysis includes a ranking of the plurality of accounts according to the likelihood of adoption by each of the plurality of accounts.

In another aspect, the analysis includes a predicted amount to be spent by each of the plurality of accounts.

In another aspect, the likelihood of adoption is over a specified period of time.

In one aspect, a device includes one or more memories having computer-readable instructions stored therein, and one or more processors. The one or more processors are configured to execute the computer-readable instructions to receive first data for a plurality of accounts, the first data including information related to feature subscriptions and adoption for each of the plurality of accounts, each account utilizing one or more devices and features of an enterprise network, receive second data for the plurality of accounts, the second data including telemetry information on network device and feature usage by one or more devices associated with each of the plurality of accounts, and generate, using a trained machine-learning model, an analysis of the plurality of accounts, wherein the machine-learning model receives the first data and the second data as input and provides a likelihood of feature adoption by each of the plurality of accounts.

In one aspect, one or more non-transitory computer-readable media includes computer-readable instructions, which when executed by one or more processors of a network component, cause the network component to receive first data for a plurality of accounts, the first data including information related to feature subscriptions and adoption for each of the plurality of accounts, each account utilizing one or more devices and features of an enterprise network, receive second data for the plurality of accounts, the second data including telemetry information on network device and feature usage by one or more devices associated with each of the plurality of accounts, and generate, using a trained machine-learning model, an analysis of the plurality of accounts, wherein the machine-learning model receives the first data and the second data as input and provides a likelihood of feature adoption by each of the plurality of accounts.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

As noted above, enterprise network providers need to understand a confluence of a variety of factors that directly and indirectly influence their users' decision-making process as far as adoption and utilization of an enterprise network and its available features are concerned. Currently, network providers rely on a network of sales representatives as points of contact with their customers. These sales representatives are tasked with ensuring user engagement and constantly look for insights into user trends and behaviors in an attempt to determine how best to maximize adoption of new features and services by these users. In doing so, sales representatives often rely on consumer reports, the creation of which is time-consuming and laborious. These reports fail to provide a holistic overview of any users' historical feature utilization and spend. Moreover, a significantly drawback of these reports is that they fail to take into consideration device telemetry data (data collected on devices and features currently in use by any given user of an enterprise network) in understanding users' behavior. Such telemetry data that can provide valuable information as to feature usage and adoption trends, frequency of use, etc.

The present disclosure provides an objective approach to understanding an account. An account may be defined for each user/customer of an enterprise network. As will be described below, this objective approach utilizes a trained machine learning model that may receive, as input, historical spend data for any given account (over a period of time) and device telemetry data that may be collected using various techniques of network devices and features currently used by any given customer. The output of the machine learning model may be a ranking of accounts with information on likelihood of future spend, likely features and network devices to be adopted by each account, predicted amount of spend over a given period of time, etc.

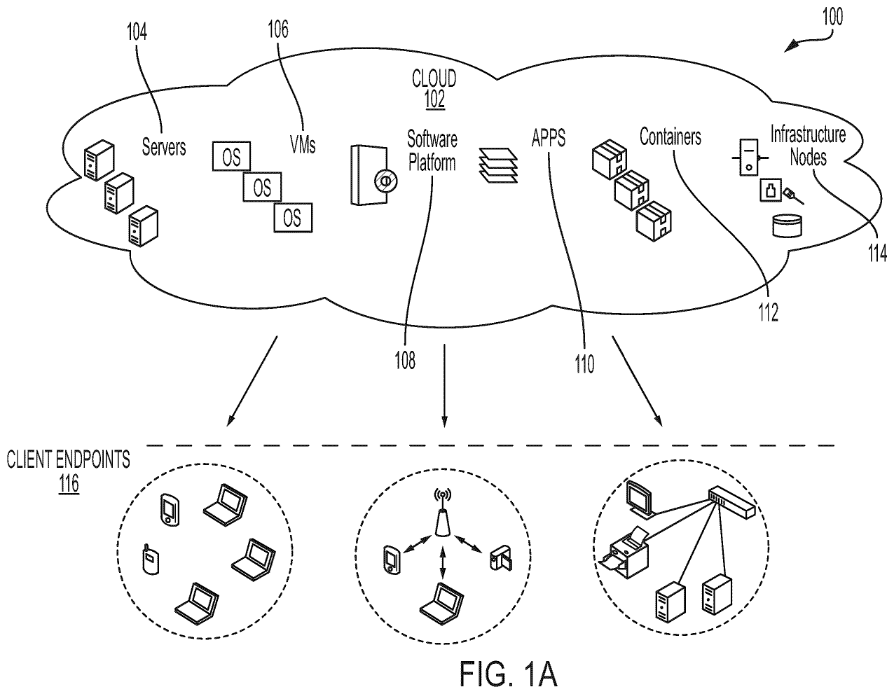

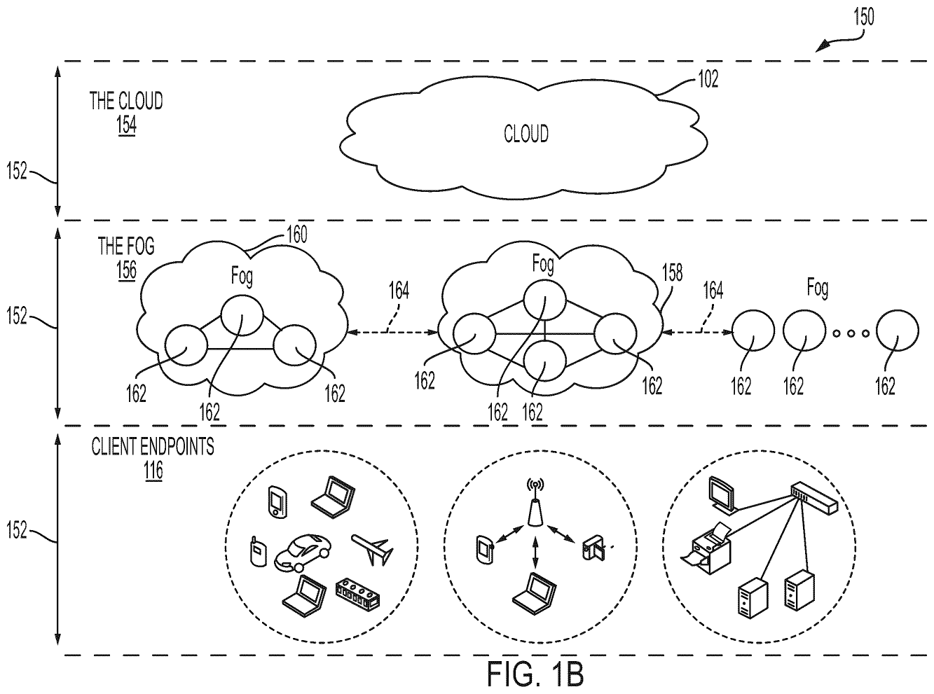

Prior to describing example embodiments of the proposed approach, example network environments and architectures for an enterprise network in which the proposed approach may be utilized are described first with reference to FIG. 1A and FIG. 1B.

FIG. 1A illustrates a diagram of an example cloud computing architecture according to some aspects of the present disclosure. The architecture 100 can include a cloud 102. The cloud 102 can be used to form part of a TCP connection or otherwise be accessed through the TCP connection. Specifically, the cloud 102 can include an initiator or a receiver of a TCP connection and be utilized by the initiator or the receiver to transmit and/or receive data through the TCP connection. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can be used to provide various cloud computing services via the cloud elements 104-114, such as SaaSs (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, a transportation system (e.g., airplane, train, motorcycle, boat, etc.), or any smart or connected object (e.g., smart home, smart building, smart retail, smart glasses, etc.), and so forth.

FIG. 1B illustrates a diagram of an example fog computing architecture according to some aspects of the present disclosure. The fog computing architecture 150 can be used to form part of a TCP connection or otherwise be accessed through the TCP connection. Specifically, the fog computing architecture can include an initiator or a receiver of a TCP connection and be utilized by the initiator or the receiver to transmit and/or receive data through the TCP connection. The fog computing architecture 150 can include the cloud layer 154, which includes the cloud 102 and any other cloud system or environment, and the fog layer 156, which includes fog nodes 162. The client endpoints 116 can communicate with the cloud layer 154 and/or the fog layer 156. The fog computing architecture 150 can include one or more communication links 152 between the cloud layer 154, the fog layer 156, and the client endpoints 116. Communications can flow up to the cloud layer 154 and/or down to the client endpoints 116.

The fog layer 156 or “the fog” provides the computation, storage and networking capabilities of traditional cloud networks, but closer to the endpoints. The fog can thus extend the cloud 102 to be closer to the client endpoints 116. The fog nodes 162 can be the physical implementation of fog networks. Moreover, the fog nodes 162 can provide local or regional services and/or connectivity to the client endpoints 116. As a result, traffic and/or data can be offloaded from the cloud 102 to the fog layer 156 (e.g., via fog nodes 162). The fog layer 156 can thus provide faster services and/or connectivity to the client endpoints 116, with lower latency, as well as other advantages such as security benefits from keeping the data inside the local or regional network(s).

The fog nodes 162 can include any networked computing devices, such as servers, switches, routers, controllers, cameras, access points, gateways, etc. Moreover, the fog nodes 162 can be deployed anywhere with a network connection, such as a factory floor, a power pole, alongside a railway track, in a vehicle, on an oil rig, in an airport, on an aircraft, in a shopping center, in a hospital, in a park, in a parking garage, in a library, etc.

In some configurations, one or more fog nodes 162 can be deployed within fog instances 158, 160. The fog instances 158, 160 can be local or regional clouds or networks. For example, the fog instances 158, 160 can be a regional cloud or data center, a local area network, a network of fog nodes 162, etc. In some configurations, one or more fog nodes 162 can be deployed within a network, or as standalone or individual nodes, for example. Moreover, one or more of the fog nodes 162 can be interconnected with each other via links 164 in various topologies, including star, ring, mesh or hierarchical arrangements, for example.

In some cases, one or more fog nodes 162 can be mobile fog nodes. The mobile fog nodes can move to different geographic locations, logical locations or networks, and/or fog instances while maintaining connectivity with the cloud layer 154 and/or the endpoints 116. For example, a particular fog node can be placed in a vehicle, such as an aircraft or train, which can travel from one geographic location and/or logical location to a different geographic location and/or logical location. In this example, the particular fog node can connect to a particular physical and/or logical connection point with the cloud layer 154 while located at the starting location and switch to a different physical and/or logical connection point with the cloud layer 154 while located at the destination location. The particular fog node can thus move within particular clouds and/or fog instances and, therefore, serve endpoints from different locations at different times.

Currently, Inside Sales Representatives (ISRs) of an enterprise network have no means to view their customer accounts data in an easy-to-use and comprehensive fashion. Each ISR is required to go through a time-consuming report building and dashboard searching to gather information on historical spend and sales data for each account. Furthermore, ISRs do not have access to any current device usage by each customer (device telemetry data) that can inform the potential for up-selling/cross-selling to current customers.

As noted above, the present disclosure provides an objective approach to understanding an account. An account may be defined for each user/customer of an enterprise network. As will be described below, this objective approach utilizes a trained machine learning model that may receive, as input, historical spend data for any given account (over a period of time) and device telemetry data that may be collected using various techniques of network devices and features currently used by any given customer. The output of the machine learning model may be a ranking of accounts with information on likelihood of future spend, likely features and network devices to be adopted by each account, predicted amount of spend over a given period of time, etc.

This approach can provide each ISR with a comprehensive view of the accounts they manage. This comprehensive view can be accessible via a dashboard that not only conveys statistics about each account but more importantly predicts their future spend and the areas in which they might spend (new devices, services, upgrades, etc., all of which may be referred to as services and features of an enterprise network).

This proposed solution is based on a trained machine learning model that can take as input two sources of data. The first source may be historical spend data for any given account (e.g., over the last quarter, last few quarters, last year, lifetime spend, etc.). The other source is device telemetry data. The telemetry data can include various information including, but not limited to, currently used devices and features by a customer, existing device configurations, information on device usage, interactions with devices, software licenses used in connection with the devices, etc.

The output of the trained machine learning model can be a ranking of the accounts for each ISR ranked according to the likelihood of their future spend and likely areas of spend (sales plays), etc. The prediction can be for the next quarter, over the next several quarters, etc.

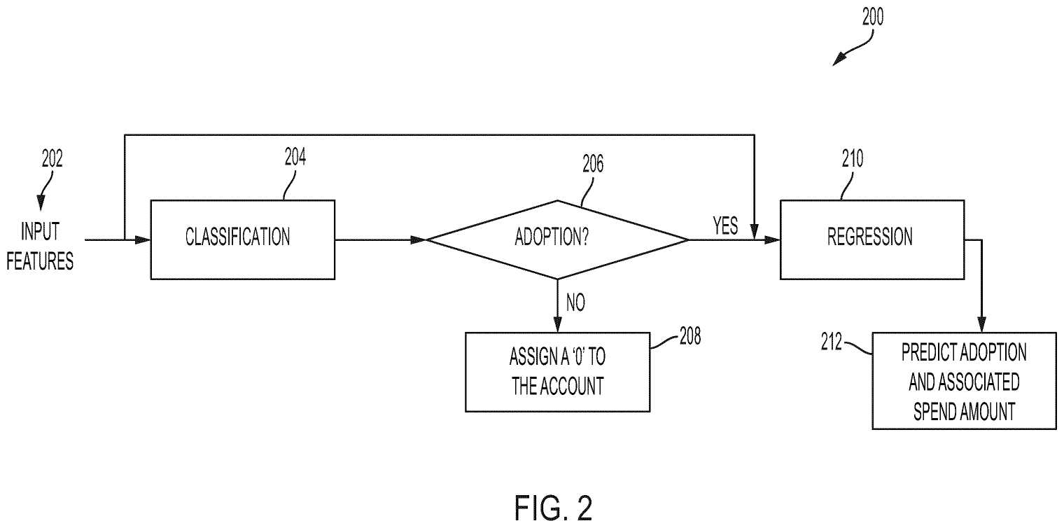

FIG. 2 illustrates an example machine learning process for account analysis according to some aspects of the present disclosure.

Example process 200 may be initiated by having input features 202 provided to a classifier for perform classification process 204. Input features 202 can be the inputs described above (e.g., historical spend data for any given account, device telemetry data, etc.).

Classification process 204 may be performed on input features 202. Any known or to be developed classifier (e.g., xgboost classifier) and the underlying classification process may be utilized.

Adoption process 206 may be performed on the classified input features to determine whether a particular account is likely to adopt additional features (whether the particular account is likely to spend). If not, at process 208, an amount of zero may be assigned to the corresponding account indicating that the account in not going to adopt features/spend.

However, if the likelihood of adoption at process 206 is yes, a regression process 210 may be applied to input features 202 to determine/predict an amount that is going to be spent by the corresponding account in a given period of time (e.g., a current quarter, next quarter, over the next two quarters, next year, etc.). The period of time may be a configurable parameter determined based on experiments and/or empirical studies. Regression process 210 may be based on any known or to be developed regression model.

Thereafter, at process 212, adoption prediction and predicted amount to be spent are provided as output of the trained machine learning model.

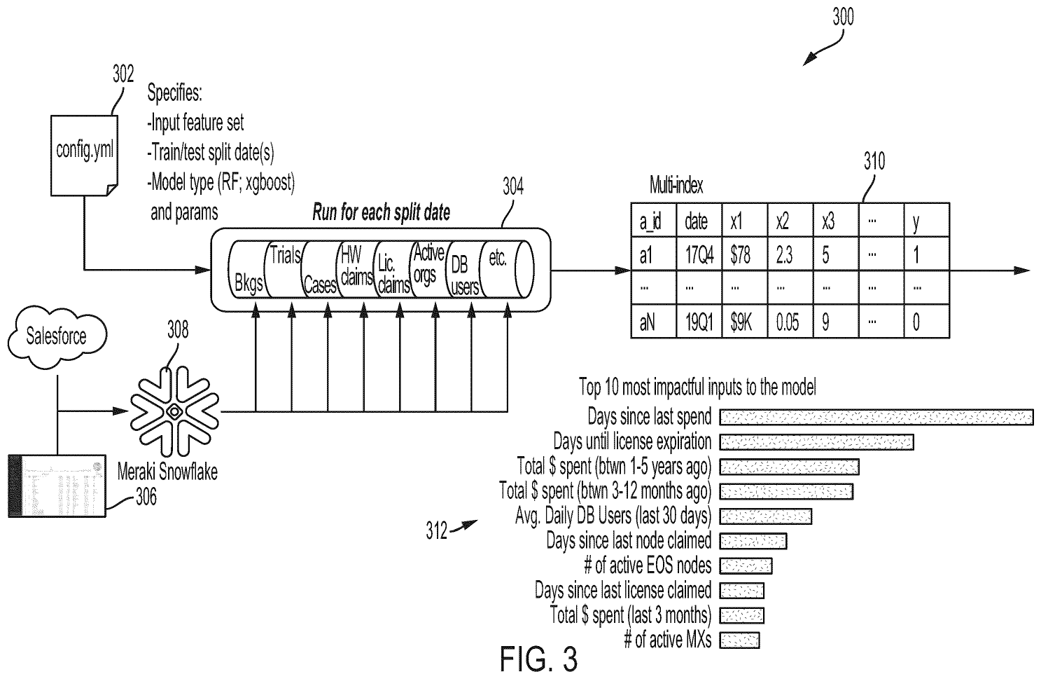

FIG. 3 illustrates an example pipeline for developing a trained machine learning model for account analysis according to some aspects of the present disclosure.

In example pipeline 300 of FIG. 3, parameters 302 for training and developing the machine-learning model are provided as input to model 304. Examples of parameters 302 include, but are not limited to, definition of input feature sets, specification of training and validation datasets and associated dates, model type and parameters, etc.

On the other hand, actual features used for training the machine learning model may be provided to model 304. Such data may be pulled from one or more internal and/or external databases such as Salesforce where historical spend data for each account may be stored as well as device telemetry data that may be retrieved from Meraki dashboard 306. Historical spend data and device telemetry data may be retrieved via Meraki Snowflake 308. Using parameters 302 and input data, model 304 may be trained/retrained with various weights and parameters adjusted continuously until model 304 is deemed trained for deployment. Examples of such weights and parameters are illustrated in table 310.

During training, validation, and/or deployment features most impactful to the output of model 304 may be identified and listed such as those shown in output 312. Such impactful features can include, but are not limited to, days since last spend by a given account, days until one or more license expirations, total amount spent by a given account over a period of time (e.g., last year, last two years, last five years, etc.), total amount spent over a recent period of time (e.g., last 1-3 months, 3-6 months, 6-12 months, etc.), average daily database users over a given period of time (e.g., last 30 days), days since last network node claimed, number of active End of Sale (EOS) nodes, days since last license claimed, highest amount spent on feature(s) over a given period of time (e.g., last month, 3 months, etc.), number of active devices (e.g., Meraki MX devices), etc.

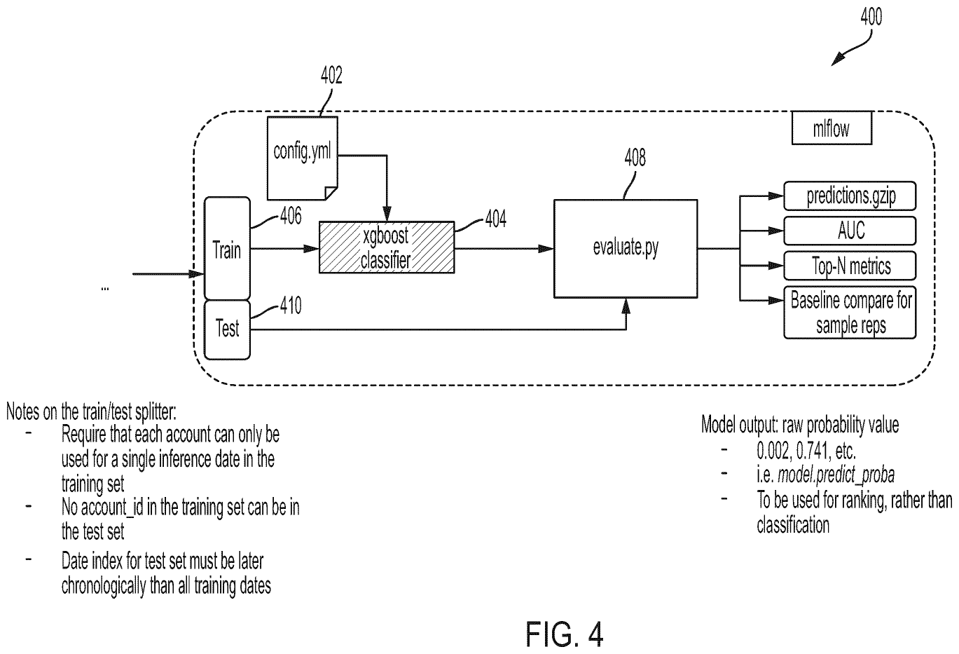

FIG. 4 illustrates an example process of training, testing and evaluating the machine learning model for account analysis described above according to some aspects of the present disclosure. As shown in setup 400 of FIG. 4, configuration parameters 402 (which may be the same as parameters 302) may be provided as input into classifier 404 (e.g., an xgboost classifier). Input features may be split into training data and test data. There may be one or more specifications/requirements associated with splitting input features into training/test data. For instance, one requirement may be that each account can only used for a single inference date in the training set, no account ID in the training set can be in the test set, and date index for test set be later chronologically than all training dates.

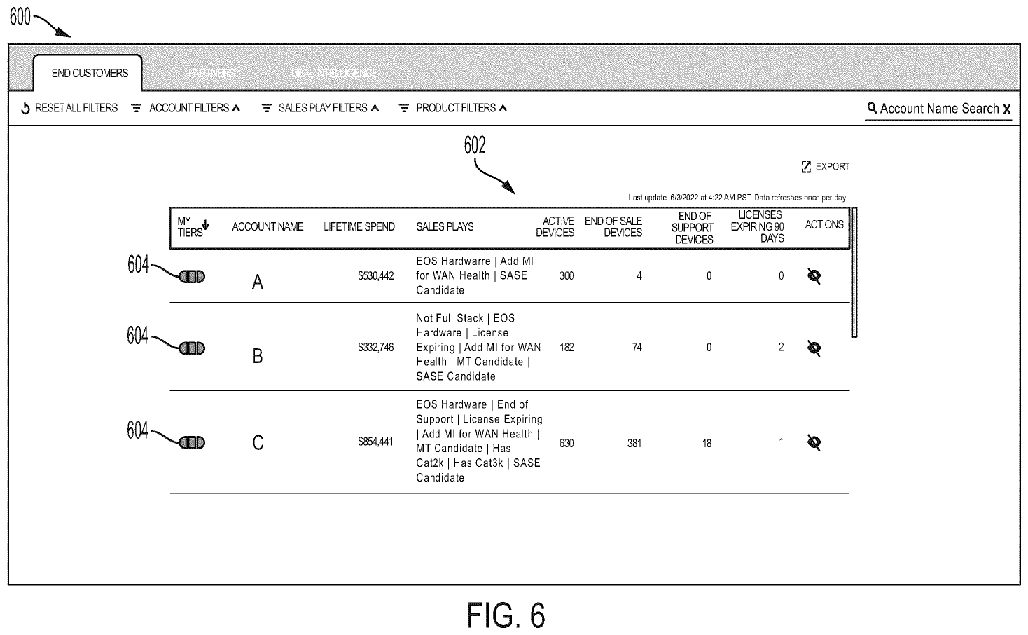

Training set 406 may also be inputted into classifier 404 along with configuration parameters 402. Once training is complete, the results may be evaluated via evaluator 408. In performing this evaluation, test set 410 may be inputted into evaluator 408 along with output of classifier 404. Output of classifier 404 may include a probability value (e.g., between 0-1) indicating the probability of an account to spend. This probability can be used for ranking accounts for each ISR on a dashboard as will be described below with reference to FIG. 6.

Output of evaluator 408 can be a file of predictions (e.g., a prediction for each account of whether they are going to spend on new/updated features in a given period of time and/or an associated predicted amount likely to be spent on each account), an Area Under the Curve (AUC) as a measure of performance of the machine learning model, top N-metrics (e.g., factors 312 described above with reference to FIG. 3), a baseline comparison for one or more ISRs, etc.

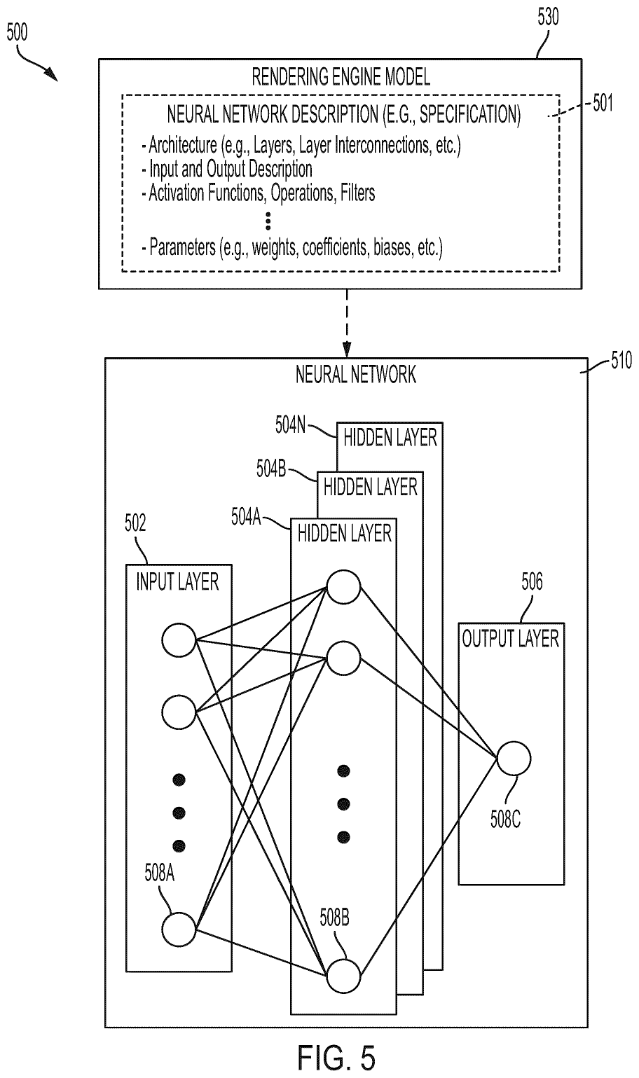

FIG. 5 illustrates an example neural network that can be utilized for feature definition and analysis according to some aspects of the present disclosure. In some examples, such neural network can also be trained to receive feature attributes and provide an analysis thereof.

Architecture 500 includes a neural network 510 that may be used for training and implementation of account analysis as described above with reference to FIGS. 2-4. Neural network 510 may be defined by an example neural network description 501 in rendering engine model (neural controller) 530. Neural network 510 can be used for feature definition and analysis. Neural network description 501 can include a full specification of neural network 510. For example, neural network description 501 can include a description or specification of the architecture of neural network 510 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

In this example, neural network 510 includes an input layer 502, which can receive input data including, but not limited to, input features 20 (e.g., historical spend data and device telemetry data as described above).

Neural network 510 includes hidden layers 504A through 504N (collectively “504” hereinafter). Hidden layers 504 can include n number of hidden layers, where n is an integer greater than or equal to one. The number of hidden layers can include as many layers as needed for a desired processing outcome and/or rendering intent. Neural network 510 further includes an output layer 506 that provides as output, a prediction of whether an account is likely to spend on new/existing features, likelihood of such spend occurring, and or the likely amount to be spent.

Neural network 510 in this example is a multi-layer neural network of interconnected nodes. Each node can represent a piece of information. Information associated with the nodes is shared among the different layers and each layer retains information as information is processed. In some cases, neural network 510 can include a feed-forward neural network, in which case there are no feedback connections where outputs of the neural network are fed back into itself. In other cases, neural network 510 can include a recurrent neural network, which can have loops that allow information to be carried across nodes while reading in input.

Information can be exchanged between nodes through node-to-node interconnections between the various layers. Nodes of input layer 502 can activate a set of nodes in first hidden layer 504A. For example, as shown, each of the input nodes of input layer 502 is connected to each of the nodes of first hidden layer 504A. The nodes of hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of the hidden layer (e.g., 504B) can then activate nodes of the next hidden layer (e.g., 504N), and so on. The output of the last hidden layer can activate one or more nodes of output layer 506, at which point an output is provided. In some cases, while nodes (e.g., nodes 508A, 508B, 508C) in neural network 510 are shown as having multiple output lines, a node has a single output and all lines shown as being output from a node represent the same output value.

In some cases, each node or interconnection between nodes can have a weight that is a set of parameters derived from training neural network 510. For example, an interconnection between nodes can represent a piece of information learned about the interconnected nodes. The interconnection can have a numeric weight that can be tuned (e.g., based on a training dataset), allowing neural network 510 to be adaptive to inputs and able to learn as more data is processed.

Neural network 510 can be pre-trained to process the features from the data in the input layer 502 using the different hidden layers 504 in order to provide the output through output layer 506. In this example, neural network 510 can be trained using training data. The training data can be a subset of data stored in a database of feature data that may be continuously collected on various network elements and/or features utilized by network elements in the network. This may be the same as training set described above with reference to FIG. 4. Another subset of the data stored in such database can be used for purposes of validating the training of neural network 510. This may be the same as the test set described above with reference to FIG. 4.

In one or more examples, training of neural network 510 may be supervised, whereby the model is trained using labeled datasets whereby one or more aspects of neural network 510, such as weights, biases, etc., are tuned until neural network 510 returns the expected result. In other examples, the training may be unsupervised.

In some examples, the training may be based on zero-shot learning and/or transfer learning.

In some cases, neural network 510 can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for neural network 510, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, neural network 510 is unable to determine low level features and thus cannot make an accurate determination of what the classification of the object might be. A loss function can be used to analyze errors in the output. Any suitable loss function definition can be used.

The loss (or error) can be high for the first training dataset (e.g., images) since the actual values will be different than the predicted output. The goal of training is to minimize the amount of loss so that the predicted output comports with a target or ideal output. Neural network 510 can perform a backward pass by determining which inputs (weights) most contributed to the loss of neural network 510 and can adjust the weights so that the loss decreases and is eventually minimized.

A derivative of the loss with respect to the weights can be computed to determine the weights that contributed most to the loss of neural network 510. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

Neural network 510 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, neural network 710 can represent any other neural or deep learning network, such as an autoencoder, a deep belief networks (DBN), a recurrent neural network (RNN), etc.

FIG. 6 illustrates an example user interface of a dashboard with account analysis results performed using machine learning model described with reference to FIGS. 2-5 according to some aspects of the present disclosure.

User interface 600 illustrates a visual ranking 602 of three example accounts A, B, and C. In providing visual ranking 602, machine learning model described above may be utilized and receive input features 202 (historical spend data as well as device telemetry data) and provide as output, a ranking of accounts A, B, and C, where the ranking may be based on the probability value of spending by accounts A, B, and C as described with reference to FIG. 4. Such probability value may be between 0 and 1. In this instance, account A has the highest probability of spending followed by account B and then followed by account C.

Each account may have an associated tier 604. For example, accounts with probability of spending within a first range (e.g., between 0.75 and 1) may receive a three-bar tier as shown indicating their importance to an ISR in charge of accounts A, B, and C. In another instance, accounts with probability of spending in a second range (e.g., between 0.5 and 0.75) may receive a two-bar tier. In another instance, accounts with probability of spending in a third range (e.g., between 0-0.5) may receive a one-bar tier.

As shown, each account may include additional accompanying information including, but not limited to, lifetime spend (e.g., in thousands of dollars or any unit of currency), possible features to be pitched to the respective account (sales plays), number of active devices, EOS devices, End of Support devices, Licenses expiring in 90 days, actions, etc.

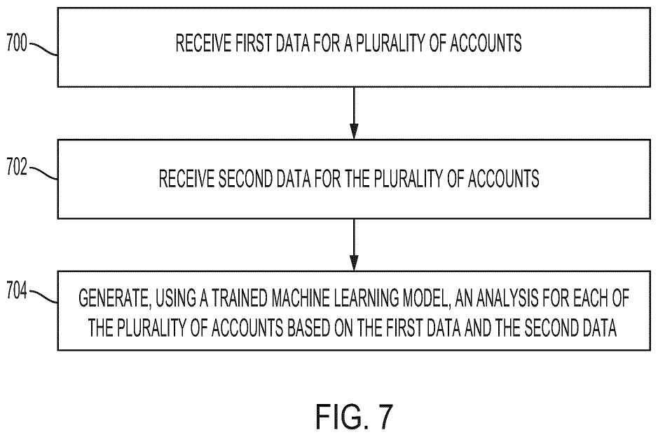

FIG. 7 is an example method of account analysis using a machine learning model developed as described with reference to FIGS. 2-6 according to some aspects of the present disclosure.

Inventive concepts described herein may be deployed in Docker containers. Hence, process of FIG. 7 and steps thereof may be described from a perspective of a network controller such as containers 112, servers 104, and/or any other network controller deployed at cloud 102, fog 156, etc.

At step 700, the network controller may receive first data for a plurality of accounts. First data may include information related to network devices, components, and/or features and services (hardware and software) of an enterprise network such as example enterprise network of FIG. 1, that a given account may utilize. Examples of the plurality of accounts include accounts A, B, and C of FIG. 6. Such information can include, but are not limited to, historical information of licenses obtained, amount spent on features and subscriptions over a number of configurable periods (e.g., last month, quarter, years 5 years, all time, etc.).

At step 702, the network controller may receive second data for the plurality of accounts. In one example, the second data can include device telemetry data for each account including, but not limited to, usage data of network devices and features that each account uses.

At step 704, the network controller may determine an analysis of each of the plurality of accounts. In doing so, the network controller may utilize a trained machine learning model, as described above with reference to FIGS. 2-6, where the trained machine learning model may receive, as input, first data and second data received at steps 700 and 702. Then, the trained machine learning model may provide, as output, the analysis of the plurality of accounts. The analysis may include a visual representation of each account and its associated information and parameters such as the non-limiting example user interface with accounts A, B, and C, as described with reference to FIG. 6. As described, the analysis and the resulting visual representation can include a ranking of the plurality of accounts according to the likelihood of adoption by each of the plurality of accounts The analysis, as described above, can provide for each account a likelihood/probability of adoption of new features, upgrades, and/or network devices in a given period of time (e.g., next month, quarter, year, etc.) and/or a predicted amount of spend on adoption of new features, upgrades, and/or device devices.

In one example, the second data is received via one or more sensors deployed throughout the enterprise network. The one or more sensors can include physical sensors installed at various nodes and devices in the network and/or can be virtual and logical codes embedded within software features available for use in the enterprise network.

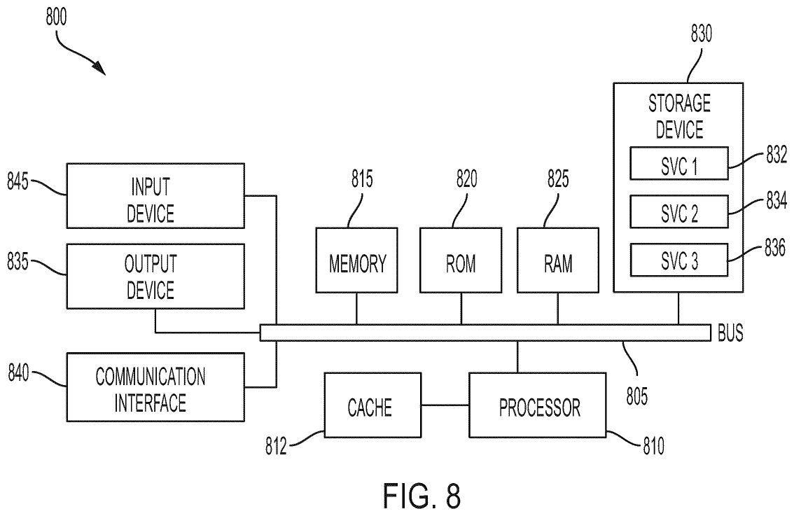

FIG. 8 illustrates an example of a computing system according to some aspects of the present disclosure. FIG. 8 shows an example of computing system 800, which can be for example any computing device making up that can perform functionalities of one or more network components described above with reference to FIGS. 1-7. Connection 805 can be a physical connection via a bus, or a direct connection into processor 810, such as in a chipset architecture. Connection 805 can also be a virtual connection, networked connection, or logical connection.

In some embodiments computing system 800 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, read only memory (ROM) 820 and random access memory (RAM) 825 to processor 810. Computing system 800 can include a cache of high-speed memory 812 connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 can essentially be a completely self-contained computing system, containing multiple cores or processors, a bus, memory controller, cache, etc. A multi-core processor can be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. There is no restriction on operating on any particular hardware arrangement and therefore the basic features here can easily be substituted for improved hardware or firmware arrangements as they are developed.

Storage device 830 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

For clarity of explanation, in some instances, the various examples can be presented as individual functional blocks comprising devices, device components, steps or routines in a method embodied in software, or combinations of hardware and software.

In some examples, the computer-readable storage devices, media, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions can be, for example, binaries, intermediate format instructions such as assembly language, firmware, or source code. Examples of computer-readable media that can be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware, and/or software, and can take various form factors. Some examples of such form factors include general-purpose computing devices such as servers, rack mount devices, desktop computers, laptop computers, and so on, or general-purpose mobile computing devices, such as tablet computers, smartphones, personal digital assistants, wearable devices, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter can have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

What is claimed is:

1. A method comprising:
receiving first data for a plurality of accounts, the first data including information related to feature subscriptions and adoption for each of the plurality of accounts, each account utilizing one or more devices and features of an enterprise network;
receiving second data for the plurality of accounts, the second data including telemetry information on network device and feature usage by one or more devices associated with each of the plurality of accounts; and
generating, using a trained machine-learning model, an analysis of the plurality of accounts, wherein the machine-learning model receives the first data and the second data as input and provides a likelihood of feature adoption by each of the plurality of accounts.

2. The method of claim 1, wherein the first data further includes historical spend data for each of the plurality of accounts.

3. The method of claim 1, wherein the second data is received via one or more sensors deployed throughout the enterprise network.

4. The method of claim 1, wherein the analysis is visually presented on a dashboard.

5. The method of claim 1, wherein the analysis includes a ranking of the plurality of accounts according to the likelihood of adoption by each of the plurality of accounts.

6. The method of claim 1, wherein the analysis includes a predicted amount to be spent by each of the plurality of accounts.

7. The method of claim 1, wherein the likelihood of adoption is over a specified period of time.

8. A device comprising:
one or more memories having computer-readable instructions stored therein; and
one or more processors configured to execute the computer-readable instructions to:
receive first data for a plurality of accounts, the first data including information related to feature subscriptions and adoption for each of the plurality of accounts, each account utilizing one or more devices and features of an enterprise network;
receive second data for the plurality of accounts, the second data including telemetry information on network device and feature usage by one or more devices associated with each of the plurality of accounts; and
generate, using a trained machine-learning model, an analysis of the plurality of accounts, wherein the machine-learning model receives the first data and the second data as input and provides a likelihood of feature adoption by each of the plurality of accounts.

9. The device of claim 8, wherein the first data further includes historical spend data for each of the plurality of accounts.

10. The device of claim 8, wherein the second data is received via one or more sensors deployed throughout the enterprise network.

11. The device of claim 8, wherein the analysis is visually presented on a dashboard.

12. The device of claim 8, wherein the analysis includes a ranking of the plurality of accounts according to the likelihood of adoption by each of the plurality of accounts.

13. The device of claim 8, wherein the analysis includes a predicted amount to be spent by each of the plurality of accounts.

14. The device of claim 8, wherein the likelihood of adoption is over a specified period of time.

15. One or more non-transitory computer-readable media comprising computer-readable instructions, which when executed by one or more processors of a network component, cause the network component to:
receive first data for a plurality of accounts, the first data including information related to feature subscriptions and adoption for each of the plurality of accounts, each account utilizing one or more devices and features of an enterprise network;
receive second data for the plurality of accounts, the second data including telemetry information on network device and feature usage by one or more devices associated with each of the plurality of accounts; and
generate, using a trained machine-learning model, an analysis of the plurality of accounts, wherein the machine-learning model receives the first data and the second data as input and provides a likelihood of feature adoption by each of the plurality of accounts.

16. The one or more non-transitory computer-readable media of claim 15, wherein the first data further includes historical spend data for each of the plurality of accounts.

17. The one or more non-transitory computer-readable media of claim 15, wherein the second data is received via one or more sensors deployed throughout the enterprise network.

18. The one or more non-transitory computer-readable media of claim 15, wherein the analysis is visually presented on a dashboard.

19. The one or more non-transitory computer-readable media of claim 15, wherein the analysis includes a ranking of the plurality of accounts according to the likelihood of adoption by each of the plurality of accounts.

20. The one or more non-transitory computer-readable media of claim 15, wherein the analysis includes a predicted amount to be spent by each of the plurality of accounts.
